(19) United States
(12) Patent Application Publication
(10) Pub. No.: US 2007/0039582 A1
(43) Pub. Date: Feb. 22, 2007

(54) Device and method for controlling an internal combustion engine

(76) Inventor: Jochen Laubender, Stuttgart (DE)

Correspondence Address: Striker, Striker & Stenby, 103 East Neck Road, Huntington, NY, 11743, US

(21) Appl. No.: 10/573,799

(22) PCT Filed: Jul. 25, 2005
(86) PCT No.: PCT/EP05/53597

§ 371 Date: Mar. 28, 2006

(30) Foreign Application Priority Data
Jul. 30, 2004 (DE) 10 2004 037 131.8

(51) Int. Cl. F02N 17/00; F02M 1/00

(52) U.S. Cl. 123/179.15; 123/179.16

(57) ABSTRACT

The invention relates to a method and a device (1) for controlling an internal combustion engine (500), in which a calculation means (410), before a start of the engine, recognizes a possible self-ignition operating state as a function of operating parameters and ascertains suitable control parameters for preventing this possible self-ignition operating state.

The invention is based on a device for controlling an internal combustion engine as generically by the preamble to the first independent main claim. The invention also relates to a method as generically defined by the preamble to the second independent main claim.

### PRIOR ART

For reducing motor vehicle fuel consumption and emissions, so-called start-and-stop methods are becoming increasingly widely used. In the present start-and-stop method, engine starting is done by means of an electrical machine, such as a belt- or crankshaft-type starter-generator, or a conventional starter. Typically, the start is done as the engine runs up to speed by injecting fuel and then igniting it, generating an engine torque, and once the engine is at a high enough rpm, the starter is disengaged again.

From European Patent Disclosure EP 1 036 928 A2, a starting device is known, in which upon shutoff of the engine, at least one cylinder entering compression is identified, and when a starting inquiry occurs, fuel is injected into that cylinder.

A problem of the starting device described in EP 1 036 928 A2, however, is the injection of fuel into a compression phase at high engine temperatures. At engine starting from “low” piston positions, near BDC (bottom dead center), the enclosed mixture reaches temperatures of over 400° C. in the compression phase, and as a result self-ignition reactions may sometimes be tripped. This can sometimes be perceived acoustically as knocking and must be avoided, for the sake of protecting components. Since these problems of self-ignition can occur especially often upon repeated starting of an engine during the start-and-stop mode of a vehicle, and moreover can occur at very short time intervals, precisely in this operating mode it must be guaranteed that the self-ignition is reliably prevented.

The self-ignition is a function of various engine parameters (engine temperature, charging, general geometric engine data such as the compression ratio), on the mixture composition (Lambda, fuel quantity, etc.), and on the injection timing. Depending on the conditions prevailing at that moment in the cylinder, it usually occurs close to top dead center or TDC (that is, the moment of the maximum compression temperature) and thus sharply restricts important engine functions programmed in the control unit, such as functions that are meant to control the efficiency of the engine torque output by way of adjusting the ignition angle, or makes it impossible to perform these functions. As a result, depending on the torque demand at the time, the engine may not be operated optimally, which adversely affects not only the running properties of the engine but also its fuel consumption and sometimes the resultant emissions.

### ADVANTAGES OF THE INVENTION

The device of the invention having the characteristics of the independent claim has the advantage over the prior art that a calculation means, before a start of the engine, recognizes a possible self-ignition operating state as a function of operating parameters and ascertains suitable control parameters for preventing this possible self-ignition operating state.

The corresponding method of the invention having the characteristics of the associated independent claim has the advantage over the prior art that even before a start of the engine, or in other words before the crankshaft is set into motion, it can advantageously be assured that at operating parameters that indicate a possible self-ignition of the fuel during starting, suitable control parameters can be ascertained on the basis of which engine components, in particular a starter or an injection device, are controlled or varied in such a way that self-ignition of the fuel or a self-ignition operating state is averted.

By the provisions recited in the dependent claims, advantageous refinements of and improvements to the method defined in the independent claim are possible.

It is especially advantageous if as a function of the control parameters, at least a starter and/or an injection device is varied. This enables a starter to operate such that the resultant piston motion, for instance, is such that self-ignition of the fuel is avoided. If influence is also exerted on the injection, then the two can advantageously be adapted to one another.

It is also advantageous if for ascertaining the control parameters, at least the position of a cylinder that on starting is the first to enter compression or begin an intake stroke and a variable that represents a combustion chamber temperature are taken into account as operating parameters. If the position of a cylinder that enters compression combustion chamber temperature first is known, then on the basis of this the control parameters can be selected, ascertained or calculated such that a self-ignition is avoided. If the combustion chamber temperature or comparably the engine or oil temperature is also known, then the control parameters can be determined more precisely, to avoid a self-ignition.

A further advantageous feature provides that the injection is varied such that in a direct-injection internal combustion engine, the fuel injection is varied such that the fuel injection does not occur until once the cylinder entering into compression has passed its top dead center. Proceeding in this way has the particular advantage that fuel is not injected until the expansion phase, thus preventing self-ignition of the fuel, since during the compression phase, only fresh air, rather than a fuel-air mixture, is compressed.

In a further advantageous feature, it is provided that the rpm of the starter is varied such that the combustion chamber temperature remains below a critical temperature threshold. This has the advantage that particularly upon a reduction in the rpm in the vicinity of top dead center, the resultant temperature rise is more moderate, and a critical temperature threshold at which the fuel can self-ignite is avoided.

A further advantageous modification provides that the rpm of the starter~is varied such that the combustion chamber pressure remains below a critical pressure threshold. This has the advantage that particularly upon a reduction of the rpm in the vicinity of top dead center, the resultant pressure rise is more moderate, and a critical pressure threshold at which the fuel can self-ignite is avoided.

Finally, a further embodiment provides that an injection quantity is increased such that the combustion chamber temperature remains below, or drops below, a critical temperature threshold. By means of an increased delivery of fuel, the fuel-air mixture is cooled, so that a self-ignition can advantageously be avoided.

### DRAWINGS

Shown are:

FIG. 1, schematically, a course of a start-and-stop operating mode;

FIG. 2, schematically, monitoring of the runup of the engine to operating speed;

FIG. 3, schematically, a control unit of the invention.

Further characteristics, possible applications, and advantages of the invention will become apparent from the ensuing description of exemplary embodiments of the invention, which are shown in the drawings. All the characteristics described or shown, alone or in arbitrary combination, form the subject of the invention, regardless of how they are summarized in the claims or the claims dependency and regardless of their wording and illustration in the description and drawings.

### DESCRIPTION

The invention is based on the concept of recognizing, on the basis of operating parameters, even before a start of the engine, whether there is a risk of a possible fuel self-ignition during starting and the runup to engine operating speed. If a potential self-ignition operating state is detected, then to prevent this operating state, suitable control parameters for starting the engine are ascertained or adapted.

Particularly in direct-injection internal combustion engines, it is helpful to ascertain the piston position of the cylinder that enters compression first, and in engines with intake-manifold injection to ascertain the piston position of the cylinder that enters the intake phase first.

For identifying the starting cylinder, an absolute angle sensor can for instance be used, which is mounted on the camshaft and/or crankshaft and indicates the instantaneous angular position of the crankshafts. The absolute angle sensor also makes it possible to synchronize the control unit with the engine faster than is possible with the conventional synchronizing methods using reference marks on the crankshaft transducer wheel and/or on a phase transducer wheel on the camshaft.

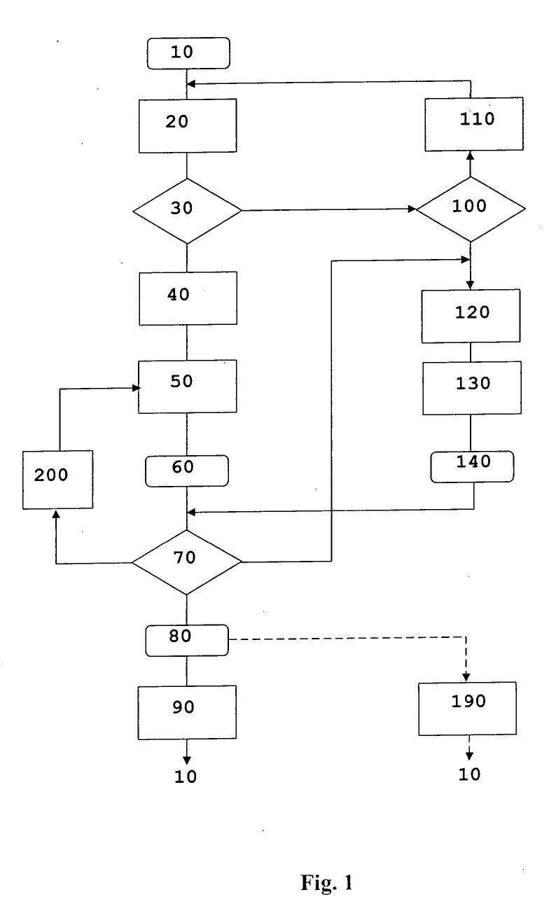

The exemplary embodiment of a start-and-stop operating mode shown schematically in FIG. 1 shows as an example one possible field or technical area in which the invention can be used.

The start-and-stop operating mode of this example is as follows: In step 10, the control unit is in a prestarting phase. In the start-and-stop operating mode, the ignition (KL15) either remains on or is briefly supplied with current at defined time intervals, so that the control unit is regularly connected with the supply voltage. As a result, the otherwise resynchronization of the control unit with the engine upon starting becomes unnecessary, and the various operating parameters of relevant engine functions are updated at regular intervals. Alternatively, this task can also be taken on by only a special partial function in the control unit during the stopped phase, so that the entire control unit need not always be activated.

In step 20, relevant operating parameters are then detected. The following operating parameters are possible examples as input variables: starting cylinder, piston position, engine temperature, engine oil temperature, coolant temperature, intake air temperature, ambient air temperature, catalytic converter temperature and fuel temperature, fuel rail pressure, ambient air pressure, fuel quality, battery voltage, valve control times, valve stroke, compression ratio, gear, clutch, position of the throttle valve, gas pedal position, brake pedal position, time, and others.

Based on the operating parameters detected or ascertained, a starting strategy is determined, on the basis of which control parameters for a runup to engine operating speed are defined. A starting strategy may for instance take cold, repeated, or hot starting into account or may be oriented to a start-and-stop operating mode or to achieving a fast runup to engine operating speed, or to further strategies for attaining optimal runup to engine operating speed. According to the invention, it is provided that in this step 20, for instance, or in following steps, on the basis of the ascertained operating parameters, it be monitored whether a self-ignition operating state could possibly occur upon starting or in the runup to engine operating speed. If such an operating state is predicted, then provision is made for adapting the starting strategy and the control parameters such that a self-ignition operating state is prevented.

In step 30, it is monitored whether the starting strategy can be executing. If conditions are unfavorable or unmet for the starting strategy, then a jump is made to step 100, in which it is decided whether a subsequent cylinder in the ignition sequence is selected—step 100—or an alternative starting event is initiated—step 120.

If suitable conditions for executing the starting strategy do exist, then in step 40 relevant control parameters are read out.

Relevant control parameters are for instance the instant of injection, angle of injection, and injection quantity; the instant and angle of ignition; the engine torque to be output; the chronological duration or angular duration of the triggering of the starter; valve control times and stroke; compression ratio; position of the throttle valve, exhaust gas recirculation valve, and others.

In step 50, the control parameters are output to the various components, for instance to an injection device and/or a starter, and in step 60, the start of the engine then takes place.

In the next step 70, preferably after an initial working stroke, it is monitored whether the control parameters have led to a runup to engine operating speed that is in accordance with the starting strategy while avoiding the predicted self-ignition. If deviations occur from the desired runup to engine operating speed, the control parameters are adapted in step 200 such that the desired runup to engine operating speed is attained. In step 50, the new control parameters are then output to the components, once again on the condition of reliable avoidance of self-ignition effects. Step 60 is skipped in this cycle, and in step 70 it is monitored again whether the runup to engine operating speed is taking place in accordance with the starting strategy. If deviations occur, the control values are optionally adapted again via step 200.

As a fallback position in the event that the start was unsuccessful, upon the monitoring in step 70 a jump is made to step 120, in which an alternative starting event is then initiated.

If starting is successful, step 80 follows, in which the engine is put into normal operation.

In the event of a stop request, the shutoff of the engine is done either regulated or unregulated, depending on the shutoff concept. With a jump to step 90, an unregulated engine shutoff is initiated, in which the crankshaft runs freely to a stop without being influenced. If a regulated engine shutoff is contemplated, step 190 follows. A regulated engine shutoff seeks to shutoff an engine and especially the crankshaft in a defined state, so that in the next start an optimal piston position is attained with a view to avoiding self-ignition and attaining a shortened starting time, optimal runup to engine operating speed, less load on the on-board electrical system, and better mixture preparation.

After the engine shutoff in step 90 or 190, a return is made to the prestarting step 10, and a new operating cycle can begin.

If in step 30 no conditions for executing the starting strategy are found, then a jump is made to step 100 as described. Preferably, the attempt is made to find a cylinder for which the conditions are met, or in other words in which the cylinder has a suitable piston position. Hence step 100 as a rule leads first to step 110. Here the next cylinder in the ignition sequence is selected, and a jump is made to step 20, so that the routine can begin again. If in step 30 no suitable condition is again recorded, then typically in step 100 the loop is repeated until such time as all the cylinders have been polled. If no suitable condition still exists, then step 100 jumps to step 120 and initiates an alternative starting event.

In step 120, the present starting strategy is first discontinued. One possible starting alternative is to keep control parameters in readiness for a nonoptimized runup to engine operating speed which however still reliably avoids a self-ignition. These control parameters may for instance be selected such that for the injection and the ignition, standard values are used, but for a preferred starting strategy, such as a start-and-stop operating mode, the starter can conversely be triggered with control parameters. A further alternative that can be provided is to initiate a “classical” normal start, in which the starter is operated in the conventional way.

In the next step 130, the control parameters are output to the components, after which the start takes place in step 140, and then in step 70 it is checked whether the start was successful.

In the event that the engine has not started, then from step 70 a return is made to step 120, and a new attempt at starting is made. After repeated failure to start, provision may also be made to initiate suitable error reactions.

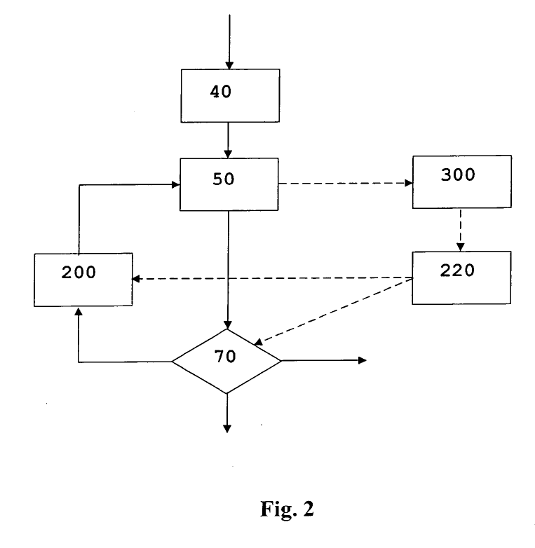

FIG. 2 shows the steps in detail after starting of the engine in step 70. As already described in conjunction with FIG. 1, control values for the starting strategy are read out in step 40 and are output in step 50 to components 300 of the engine, and then in starting takes place in step 60 (not shown in FIG. 2). After the onset of starting, essentially independently of the other steps, operating parameters are read in, for instance continuously or at defined time intervals, in a step 220, so that a chronological course of relevant operating parameters can optionally be ascertained.

After the onset of starting, in step 70, on the basis of the operating parameters ascertained in step 220, it is checked whether a runup to engine operating speed that avoids self-ignition, in accordance with the specified starting strategy, is taking place. If the ascertained operating parameters deviate from the operating parameters expected for the starting strategy, then in step 200 the control values are adapted such that the desired runup to engine operating speed is achieved. The new control values are output to the components 300 in step 50, and the success is checked in step 70, and if there are still deviations, a return is made is made to step 200 again.

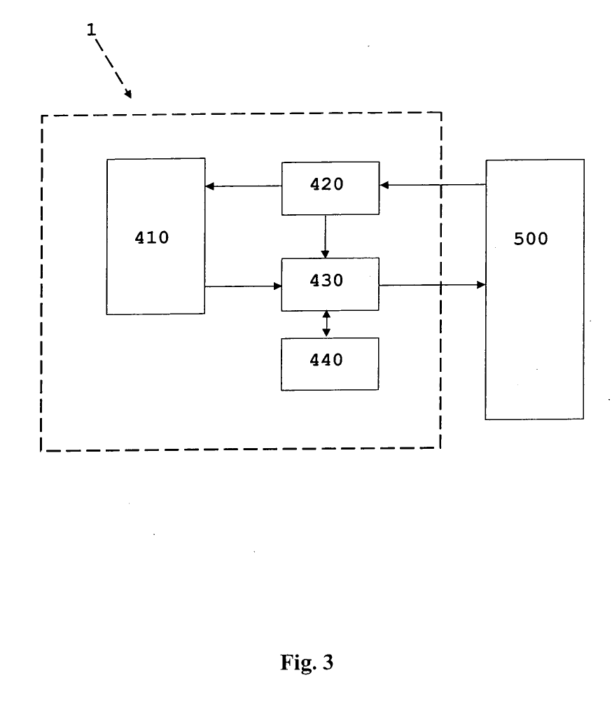

In FIG. 3, a device 1 for controlling an internal combustion engine 500 is shown, outlined in dashed lines. The device 1, preferably a control unit, includes a calculation means 410, a detection means 420, a control means 430, and a memory means 440.

The detection means 420, preferably a receiver, analog-to-digital converter, or the like, detects operating parameters of the engine and carries signals accordingly onward to the calculation means 410 and the control means 430. The calculation means 410, preferably a microprocessor or in general an arithmetic unit, calculates or ascertains, from the detected operating parameters, a starting strategy suitable for starting the engine and defines control parameters such that the runup to engine operating speed takes place in accordance with the desired starting strategy with reliable avoidance of self-ignition effects. The control parameters and optionally the starting strategy are sent onward to the control means 430. The control means 430 may for instance be constructed as a separate unit or it may be part of the functionality of the calculation means. Via the control means 430 and optionally other function modules, components of the engine are triggered with the defined control parameters. The control means 430, on the basis of detected operating parameters, checks whether the runup to engine operating speed upon starting is in accordance with the specified starting strategy. If the runup to engine operating speed or certain operating parameters deviate from the parameters expected for the starting strategy, then for attaining an optimal runup to engine operating speed in accordance with the desired starting strategy, the control means 430 adapts the control parameters accordingly. The adapted control parameters are stored in memory in a memory means 440, so that for a new start with a suitable starting strategy, already-adapted values are available.

For outputting the control parameters in accordance with the starting strategy, the control parameters may for instance be stored in memory in families of curves, characteristic curves, special truth tables, memory units of a neural network, or other memory units, and can also be learned adaptively, so that starting that is optimized in terms of time, fuel consumption and emissions is always achieved.

As a function of the operating parameters, the optimal starting strategy and corresponding control parameters ascertained and defined, for attaining optimal starting conditions for the engine. If despite the preselected control parameters nonoptimal operating states nevertheless ensue, such as fuel self-ignitions, then for the next start the control parameters are selected such that a new occurrence of these effects is prevented. However, it must then be assured that by the new choice of what are now not optimally selected precontrol variables, 100% starting reliability is nevertheless attained; optionally, the precontrol values must also be adapted.

Alternatively, a switchover can be made to operation using classical starter starting (that is, making the starter turn over longer). The same is true after a start has been discontinued or in an unsuccessful attempt at starting during a start-and-stop operating mode.

If in general the conditions for a successful “starter-reinforced direct start”, for instance after polling the ambient conditions, are not entirely met in the engine before starting for the applicable starting cylinder, for instance in the case where the piston position of the starting cylinder is not optimal, then it is also possible by means of turning over the starter to change the next cylinder in the ignition sequence from the intake stroke to the compression stroke and to execute the starting routine with this cylinder.

A device or control unit according to the invention with engine control functions programmed in it makes it possible to output injection pulses and ignition pulses separately from one another and at arbitrary times or crankshaft angles. It also makes it possible to trigger an electrical machine, such as a starter or starter-generator, with variable timing or variably over the camshaft or crankshaft angle. It also makes it possible, in systems with variable compression or valve control, to vary the compression ratio, or the phase and stroke position of the inlet and outlet valves, during the starting procedure.

In systems with variable valve control, either the fill level in the compression phase or the engine torque output can also be controlled by adjusting the valve control times for the inlet and outlet camshafts. In the compression phase, the fill level in the compression cylinder can be varied as a function of ambient conditions in the engine, for instance by earlier or later closure of the injection valve.

One possible starting strategy can for instance provide a special regulation algorithm and thus predict or simulate the temperature course during the compression phase, for instance on the basis of the compression ratio, the mass of air enclosed in the cylinder, and the starter rpm. After that, the output variables of the regulating algorithm or the control values can be set such that a critical temperature for the self-ignition is not exceeded.

In systems with variable compression, it is additionally possible during the compression and combustion process to vary the compression ratio, so as to control the compression temperature and the compression pressure. If it is found from a temperature or combustion chamber pressure sensor, for instance, that the compression temperature or the compression pressure is too high, then the engine compression is decreased (causing expansion of the cylinder for a greater displacement). Conversely, if the compression temperature or the compression pressure is too low for optimal mixture preparation, then the compression ratio of the engine is increased.

In the procedure according to the invention, the problem of self-ignition at high engine temperatures is averted by means of purposeful adaptation of compression, injection and ignition.

The prior triggering of a starting as a starter-reinforced provision is done in such a way that in the compression phase, a possible self-ignition is reliably prevented. This can mean on the one hand that as a function of the piston position upon starting, the starter, is capacity-controlled in the compression phase such that a defined temperature increase or pressure increase in the combustion chamber is attained during the compression.

On the other hand, however, the triggering of the starter can also be done such that during the compression phase, based on the starter rpm, an optimal mixture preparation time for the subsequent combustion is created. This means that on the basis for instance of the fuel quality, the engine temperature, coolant temperature, or oil temperature, the engine compression and so forth, the starter rpm, or the resultant piston speed is controlled such that in the compression phase, the most homogeneous possible fuel-air mixture is formed in the cylinder and is then ignited.

By purposeful monitoring of the combustion chamber temperature, for instance by means of a temperature sensor, or of a pressure course by means of a combustion chamber pressure sensor, the compression temperature, for instance, can be kept below the critical temperature for a self-ignition, by purposefully outputting heat to the cylinder wall.

Additionally, depending on the starting position, the starter is triggered on the basis of either angle or time only as long as is necessary to assure the predefined rpm upon passing TDC. That is, as earlier as possible, the starter is actively turned off again, to avoid unnecessary loads on the on-board electrical system or starting noise.

As the starting cylinder for the first combustion, the cylinder in the compression stroke is used, which is identified before the start, for instance by means of an absolute angle sensor on the crankshaft.

As described, it is also provided that fuel be injected into the cylinder and that the fuel-air mixture then be ignited not primarily before or during the compression phase in the compression cylinder, but only after top dead center has been passed, or in other words once the piston is already in the expansion phase of the working stroke.

The primary injection after TDC has several advantages: First, the problems of self-ignition are prevented here because what is compressed is not a premixed fuel-air mixture but only fresh air. That is, during the compression phase there is no ignitable mixture in the cylinder that could self-ignite as a result of the high compression temperatures. Unintentional knocking combustion that can damage the engine is thus effectively suppressed. Second, because self-ignition is avoided, the choice of the instant of ignition is not restricted, so that by varying the instant of injection and ignition and the fuel quantity, the combustion torque generated and thus directly the engine torque output, can be controlled such that the runup to engine operating speed follows a defined rpm course, so that engine vibration, for instance, which might occur as a result of the initial combustions (that is, full-load compressions and combustions) and can be annoyingly transmitted to the passenger compartment (impairing passenger comfort) can be minimized or prevented, or an overswing in rpm past the desired idling rpm, of the kind that at present usually occurs in the starting process, can be reduced, so that the engine reaches its desired operating state faster. Attaining the desired engine operating state quickly is essential in the start-and-stop operating mode for the sake of a fast takeoff, for instance after stopping at a light. A reduced overswing in rpm also has an effect on the starting noise of the engine. Engine “screeching” because of an excessively high rpm in starting is thus effectively prevented.

The course of the injection and ignition can be based on time or angle or both. This starting method can also be employed on the second and further combustion events that follow in the ignition succession, so as to reliably avoid self-ignition effects there as well.

In other words, the starting routine, as shown in FIG. 1 or FIG. 2, regulates the various parameters (instant of injection, injection quantity, instant of ignition) for the subsequent combustion, on the basis of the rpm or rpm gradient course of the previous combustion, in order to reliably avoid self-ignition effects or attain starting that is optimized in terms of time, fuel consumption, and emissions.

Alternatively, the injection pulses and ignition pulses can be made, dependent on the aforementioned input variables or operating parameters, also before or during the compression phase, however, or in other words even before top dead center is reached. Then, however, on the basis of the input variables (such as engine, coolant, oil, and intake air temperature, and so forth), it must be assured that any self-ignition effects can be reliably precluded.

This can be achieved as described above, for instance by targeted triggering of the starter, for instance by monitoring the compression temperature and keeping it below a critical temperature threshold for the self-ignition by means of targeted wall heat losses to the cylinder wall.

A further alternative is as described an increased injection quantity (enrichment) for the initial combustions, since thus the air enclosed in the cylinders is cooled down more strongly (greater vaporization enthalpy), and the temperature in the combustion chamber can thus be brought to below the self-ignition temperature.

The invention is furthermore suitable for a start-and-stop system in vehicles with intake-manifold injection (SRE). The injection pulses for the individual cylinders must be made here during the intake stroke with the inlet valves open or must be stored in advance in the intake manifold while the inlet valves are still closed. Thus even in these systems, a possible self-ignition in hot starting can be reliably prevented.

The starter triggering then takes only slightly longer than the maximum triggering time of the starter of approximately one-half a revolution of the crankshaft (approximately 1800 of crankshaft angle), and direct gasoline injection systems with injection into the compression stroke. The starter is triggered in the same way as described for the systems with direct injection for avoiding self-ignition effects.

The risk of self-ignition at high engine temperatures must be prevented in SRE start-and-stop systems, for instance by an increased injection quantity (enrichment) during the intake stroke or just before opening of the inlet valves. By means of a pre-stored injection into the intake manifold shortly before the opening of the inlet valves or during the intake stroke, the aspirated air, which for instance in a stopped phase in the start-and-stop operating mode heats up excessively because of the engine heat output and also from strong sunshine, is cooled down by the vaporization of the liquid fuel. Thus the temperature of the fuel-air mixture is reduced markedly and in the ensuing compression can be kept below the temperature threshold for self-ignition. In the start-and-stop operating mode, worsening of the emissions from an increased injection quantity would be rendered harmless by the already heated-up catalytic converter and would thus be unproblematic. However, it must be assured that during a long stopped phase, for instance, the temperature in the catalytic converter does not drop below the conversion temperature.

1. A device (1) for controlling an internal combustion engine (500), characterized in that
a calculation means (410), before a start of the engine, recognizes a possible self-ignition operating state as a function of operating parameters and ascertains suitable control parameters for preventing this possible self-ignition operating state.

2. A method for controlling an internal combustion engine, characterized in that before a start of the engine, as a function of operating parameters, a possible self-ignition operating state is recognized, and control parameters suitable for preventing this possible self-ignition operating state are ascertained.

3. The device or method as defined by claim 1, characterized in that as a function of the control parameters, at least a starter and/or an injection device is varied.

4. The device or method as defined by claim 1, characterized in that for ascertaining the control parameters, at least the position of a cylinder that on starting is the first to enter compression or begin an intake stroke and a variable that represents a combustion chamber temperature are taken into account as operating parameters.

5. The device and method as defined by claim 4, characterized in that for ascertaining the control parameters, an intake air temperature is taken into account.

6. The device and method as defined by claim 1, characterized in that in a direct-injection internal combustion engine, the fuel injection is varied such that the fuel injection does not occur until once the cylinder entering into compression has passed its top dead center.

7. The device or method as defined by claim 1, characterized in that the rpm of the starter is varied such that the combustion chamber temperature remains below a critical temperature threshold.

8. The device or method as defined by claim 1, characterized in that the rpm of the starter is varied such that the combustion chamber pressure remains below a critical pressure threshold.

9. The device or method as defined by claim 1, characterized in that an injection quantity is increased such that the combustion chamber temperature remains below, or drops below, a critical temperature threshold.
